(19) United States
(12) Patent Application Publication
(10) Pub. No.: US 2023/0271771 A1
(43) Pub. Date: Aug. 31, 2023

(54) SPRAY DEVICES FOR HAIR CARE COMPOSITIONS WITH A COMPRESSED GAS PROPELLANT

(71) Applicant: The Procter & Gamble Company, Cincinnati, OH (US)

(72) Inventors: Casey Robert Albertz, Miami Heights Township, OH (US); Debra Sue Binski, West Chester, OH (US); Matthew John Martin, California, KY (US); David Frederick Swaile, Cincinnati, OH (US)

(21) Appl. No.: 18/314,895

(22) Filed: May 10, 2023

Related U.S. Application Data
(63) Continuation-in-part of application No. 17/847,211, filed on Jun. 23, 2022.
(60) Provisional application No. 63/216,652, filed on Jun. 30, 2021.

(51) Int. Cl. B65D 83/66; B65D 83/48

(52) U.S. Cl. CPC B65D 83/66; B65D 83/48

(57) ABSTRACT

An aerosol hair care product that includes a dispenser container containing a compressed gas, an adsorbent material, a propellant and a reservoir filled with a hair care composition such as a hairspray or dry shampoo. The hair care composition is dispensed from the container without substantial clogging in the valve assembly or outlet nozzle and exhibits no substantial change to the mass flow rate and/or average particle size distribution over the life of the product.

### TECHNICAL FIELD

The present disclosure relates generally to spray devices containing a hair care composition and a propellant. More specifically, the present disclosure relates to an aerosol hair care composition. Even more specifically, the present disclosure relates to an aerosol hair care composition in combination with a non-hydrocarbon propellant and a container that contains an adsorbant material to adsorb the propellant.

### BACKGROUND

Hair care products such as hairsprays and dry shampoos are well known in the art. These types of hair care products are commonly packaged in pressurized aerosol containers with a release valve to dispense the pressurized product into the air as an aerosol. In some instances, the container may be pressurized with a hydrocarbon propellant (e.g., volatile liquid hydrocarbon). Hydrocarbon propellant can be advantageous to use because the pressure inside the container turns the gas into a liquid and, as the hair care product is dispensed, more propellant evaporates into the headspace above the product to maintain a relatively constant pressure, which in turn yields consistent spray properties (e.g., spray rate and average particle size distribution).

While hydrocarbon propellants are useful, some consumers prefer non-hydrocarbon propellant, such as compressed gases (e.g., air, nitrogen, inert gases, and carbon dioxide). However, it can be difficult to make a consumer acceptable aerosol hairspray product that uses a compressed gas propellant because, unlike liquified hydrocarbons, the compressed gas propellant is always in the vapor state and therefore the pressure in the container is reduced as product is dispensed, making it difficult to dispense the hairspray composition at a consumer acceptable particle size distribution and spray rate over the life of the container. As the pressure inside the container drops, the average particle size distribution increases, eventually releasing globs of hairspray that take too long to dry and can make the hair look dull, limp, and stiff. Eventually, the pressure can be so low that no product is released at all, even if there is product left in the can.

Still other consumers and/or manufacturers may prefer a mechanical means such as a bag-on-valve device, in which an elastic or plasto-elastic bag containing the composition is disposed in the container. The container can be pressurized with a propellant around the bag. The valve is operatively connected to the bag and to an actuator. When the actuator is actuated, the propellant surrounding the bag provides sufficient pressure to squeeze the bag and expel the contents through a nozzle or other dispenser. However, bag-on-valve devices may suffer some of the drawbacks that compressed gasses face, such as decreased pressure and poor product performance towards the end of product life.

The relationship between various mechanical components of a hairspray product (nozzle, valve, valve stem, dip tubes, etc.) and the rheological properties of the hairspray composition can also lead to poor product performance (e.g., globbing, low spray rate and undesirable spray pattern). Thus, it can be important to tailor the mechanical elements and rheological elements of the hair care product to provide suitable product performance.

In addition to good product performance, at least some consumers prefer product ingredients and packaging that are environmentally friendly. However, conventional hair styling products continue to be made from virgin materials and/or petrochemical derived materials.

Therefore, there is a need for an aerosol dispenser that contains a hairspray product and a compressed gas propellant with consistent spray properties, such as spray rate and average particle size distribution for the life of the container. There is also a need to provide the hairspray product in an environmentally friendly container.

### SUMMARY

Disclosed herein is an aerosol hair care product comprising a container; an actuatable valve assembly joined to the container, a compressed gas propellant selected from nitrogen, carbon dioxide and combinations thereof contained in the container, an adsorbent and a reservoir disposed inside the container. The actuatable valve assembly comprises a nozzle, a mounting cup, one or more gaskets, a valve seat, a spring, a dip tube and a housing. The reservoir contains a hair care composition comprising an anionic hairstyling polymer and an ethanol-free carrier and is operatively connected to the actuatable valve assembly via a first dip tube and a second tube. When the valve assembly is actuated, the composition and compressed gas propellant travel along the first tube and the second tube, respectively, and mix in the valve assembly before exiting the dispenser container via an actuator spray nozzle. Alternatively, the compressed gas propellant travels along the second tube into the reservoir and carries the composition along the first tube where they mix in the valve assembly before exiting the dispenser container via the actuator spray nozzle. When the composition and propellant are dispensed, the compressed gas is released from the adsorbant in the container and refreshes the lost pressure in the headspace.

### BRIEF DESCRIPTION OF THE DRAWINGS

FIG. 1 is an exploded view of a bag-on-valve assembly.

FIG. 2A is an exploded view of an embodiment of a valve assembly of the present invention.

FIG. 2B is an exploded view of a dispenser comprising the valve assembly of FIG. 2A.

FIG. 2C is a side elevation of the dispenser of FIG. 2B.

FIG. 2D is a sectional view of the dispenser of FIG. 2B.

FIG. 3 is a sectional view of an embodiment of a container of the present invention.

### DETAILED DESCRIPTION

Hydrocarbon propellants are commonly used in aerosol hair care products such as hairsprays and dry shampoos, and are typically present in the aerosol spray device as both a gas and a liquid that is miscible with the liquid hair care composition. Some non-limiting examples of hydrocarbon propellants include butane, propane, dimethyl ether, isobutane, 1,1-difluoroethane, or mixture thereof. On discharge, the gas phase propellant “propels” the liquid in container (including dissolved, liquid phase propellant through the nozzle). Hydrocarbon propellants are popular because they generally provide consistent spray properties over the life of the product. For example, a large proportion of the liquefied hydrocarbon propellant gas “flash vaporizes” during discharge from the spray device, and this rapid expansion gives rise to a fine spray. In contrast, it can be difficult to get suitable fine sprays using compressed air. However, it has now been found that when a suitable hair care product is coupled with a compressed air propellant, such as nitrogen, and dispensed using the valve assembly described herein, consumer preferred spray properties (e.g., spray rate, particle size, spray diameter) throughout the life of the product can be achieved.

“About” modifies a particular value by referring to a range of plus or minus 20% or less of the stated value (e.g., plus or minus 15% or less, 10% or less, or even 5% or less).

“Disposed” means that an element(s) is formed (joined and positioned) in a particular place or position as a macro-unitary structure with other elements or as a separate element joined to another element.

“Hair” means mammalian hair including scalp hair, facial hair and body hair, more preferably hair on the human head and scalp. “Hair shaft” means an individual hair strand and may be used interchangeably with the term “hair.”

“Joined” means configurations whereby an element is directly secured to another element by affixing the element directly to the other element, and configurations whereby an element is indirectly secured to another element by affixing the element to intermediate member(s) which in turn are affixed to the other element.

“Life of the product” means the time from when the container contains 100% of the hair care composition initially placed in the container (“full can”) to when the container contains 25% or less of the hair care composition initially placed in the container (“end of can”).

“Molecular weight” or “M.Wt.” refers to the weight average molecular weight unless otherwise stated. Molecular weight can be determined according to the industry standard method of gel permeation chromatography (“GPC”).

“Substantially free of” means about 2% or less (e.g., 1% or less, 0.5% or less, or 0.1% or less) of a stated ingredient. “Free of” means no detectable amount of the stated ingredient or thing.

“Water-soluble” means a material is sufficiently soluble in water to form a single-phase solution to the naked eye at a concentration of 0.1% by weight of the material in water at 25 ° C. It may be necessary to adjust the pH of the mixture or fully neutralize the mixture after addition of the material to water to achieve the water solubility. These methods are known, for example, in the water-soluble hairstyling polymer applications industry and are typically instructed with the supplied material sample. Water-solubility is typically measured by the following protocol: 0.1% by weight of the material is added to distilled water at 25° C. and the pH adjusted/neutraliser added as needed. This is stirred vigorously on a magnetic stirrer set at 600 rpm, for 30 minutes. The solution is then allowed to settle for 1 hour and the number of phases observed by the naked eye. For example, where any solid material can be seen in an otherwise single-phase solution, then it is considered two phases.

All percentages are by weight of the total composition, unless specifically stated otherwise. All ratios are weight ratios, unless specifically stated otherwise. All ranges are inclusive and combinable. The number of significant digits conveys neither a limitation on the indicated amounts nor on the accuracy of the measurements. All numerical amounts are understood to be modified by the word “about” unless otherwise specifically indicated. Unless otherwise indicated, It should be understood that every maximum numerical limitation herein includes every lower numerical limitation, as if such lower numerical limitations were expressly written, and every minimum numerical limitation includes every higher numerical limitation, as if such higher numerical limitations were expressly written herein. Numerical ranges herein are intended to include every narrower numerical range that falls within such broader numerical range, as if such narrower numerical ranges were all expressly written herein.

All measurements herein are understood to be made at 25° C. and at ambient conditions, where “ambient conditions” means conditions under one atmosphere of pressure and at 50% relative humidity. All such weights as they pertain to listed ingredients are based on the active level and do not include carriers or by-products that may be included in commercially available materials, unless otherwise specified.

Hair Care Products

The hair care products described herein are aerosol hair care products and do not include mousse products or pump spray products. The aerosol hair care product can be ethanol-based or ethanol-free (e.g., water-based). The aerosol hair care product includes a container with at least one wall that defines an internal storage space. Disposed in the internal storage space is a reservoir (e.g., elastic bag) containing a hair care composition, a compressed gas propellant and an adsorbent capable of adsorbing the compressed gas propellant (e.g., activated carbon). The compressed gas propellant and hair care composition may be stored in the same or separate portions of the internal storage space. For example, the hair care composition may be contained inside an elastic bag reservoir and the propellant stored outside the elastic bag reservoir. In some aspects, the reservoir may contain 50% to 100% hair care composition (e.g.,55% to 95%, 60% to 90% or even 65% to 85%), by volume. The container can be pressurized with a compressed gas propellant up to 160 psig (50-160 psig, 60-150 psig or 70 to 140 psig). Unless otherwise stated, details of the hair care composition and propellant refer to these ingredients before they are placed in the container.

Hairspray

In some aspects, the hair care composition is a hair spray product. Hairsprays are typically used to keep hair in place, protect hair from humidity and volumize hair. Providing a suitable spray rate and droplet size can deliver desirable hairspray properties, for example, as shown in Table 1 below. In particular, the properties shown in Table 1 are desired at the initial spray when the container is full and when there is 25% or less of the hairspray composition remaining in the container. Accordingly, the spray properties in Table 1, collectively or individually, should vary by no more than 30% (e.g., no more than 25%, 20%, 15%, or even 10%) between the initial/full container measurements and when 25% of the composition remains. In some aspects, it may be desirable for the spray droplet size to vary by no more than 30 μm (e.g., no more than 25 μm, 20 μm, 15 μm, or even 10 μm). The spray properties shown in Table 1 can be determined according to known test methods. For example, suitable methods of determining Spray Diameter and average Particle Size Distribution 5 (Dv50) are found in co-pending PCT Application No. PCT/US23/61540, filed on January 20, 2023 by Brown, et al.

TABLE 1
Spray Properties

| | | |
|---|---|---|
| Ethanol- | Spray Rate | 0.3 g/sec to 1.0 g/sec |
| based | Dv50 Droplet | 40 μm to 90 μm |
| | Size | |
| | Spray | 5 cm to 15.25 cm |
| | Diameter | |
| Ethanol-free | Spray Rate | 0.3 g/sec to 1.0 g/sec |
| | Dv50 Droplet | 20 μm to 100 μm |
| | Size | |
| | Spray | 5 cm to 15.25 cm |
| | Diameter | |

In some aspects, the hair spray composition is dispensed as a multitude of droplets having an average particle size distribution (Dv50) of 20 microns to 100 microns, (e.g., 30 μm to 90 μm, 40 μm 10 to 80 μm or 50 μm to 70 μm), as determined by the Particle Size Distribution Test described below. The spray delivery rate for ethanol-based hairsprays can be 0.2 g/s to 0.9 g/s (e.g., 0.25 g/s to 0.8 g/s, 0.28 g/s to 0.75 g/s, or0.3 g/s to 0.7 g/s), as determined by the Delivery Rate Test Method. The spray delivery rate for ethanol-free hairsprays can be 0.2 g/s to 0.9 g/s (e.g., 0.25 g/s to 0.8 g/s, 0.28 g/s to 0.75 g/s, or0.3 g/s to 0.7 g/s), as determined by the Delivery Rate method. The kinematic viscosity of an ethanol-free hairspray composition herein, without propellant, can be 0.5 cSt to 5.5 cSt (e.g., 1 to 5 cSt, 1.25 to 4.5 cSt, 1.5 to 4.0 cSt, 1.75 to 3.5 cSt, 1.8 to 3 cSt, or even 2.0 to 2.5 cSt). The kinematic viscosity of an ethanol-based hairspray composition herein, without propellant, can be 1 to 20 cSt (e.g., 3 to 18 cSt, or 5 to 15 cSt).

The hairspray composition can include 1.5% to 10% hairstyling polymer, by weight of the hairspray composition. The amount of hairstyling polymer is important in balancing hold performance and on-hair wetness. The amount of hairstyling polymer drives the hold performance, but is limited by a maximum sprayable viscosity. The hairspray composition can include 2% to 8% (e.g., 3% to 7% or 3.5% to 6%) hairstyling polymer, by weight of the hairspray composition. These amounts may be the total amount of hairstyling polymer in the hairspray composition.

The hairstyling polymer or mixture of hairstyling polymers can be water-soluble hairstyling polymers and/or ethanol/alcohol-soluble hairstyling polymers that can provide a viscosity of 6 cSt or less as measured before the addition of propellant. This hairspray composition containing soluble hairstyling polymer(s) is then pressurized in a can with a gas propellant. In some examples, a user may shake the can prior to dispensing in order to mix the hairspray composition with the hairstyling polymer and the propellant.

The hairstyling polymer may be any water-soluble or alcohol-soluble film-forming polymer or mixture of such polymers. This includes homopolymers or copolymers of natural or synthetic origin having functionality rendering the polymers water-soluble such as hydroxyl, amine, amide or carboxyl groups.

The soluble hairstyling polymers when diluted at the range claimed, can form transparent or semi-transparent stable solutions. Depending on the specific polymer type, it may be necessary to adjust the pH of the formulation or to neutralize the formulation after addition of the polymer to water to achieve water solubility. The hairstyling polymer may be classified into two types, (totally) synthetic polymers and natural products together with their chemically modified derivatives and further can be grouped into three main headings; naturally occurring, semi-synthetic and completely synthetic polymers. The hairstyling polymer can be selected from the group consisting of: cationic hairstyling polymers, anionic hairstyling polymers, nonionic hairstyling polymers, and amphoteric hairstyling polymers. The molecular weight of the hairstyling polymers should be such that the hairspray composition without propellant meets the viscosity requirement range specified. The hairstyling polymers can be linear or branched.

The hairstyling polymer may be a cationic hairstyling polymer, anionic hair styling polymers, non-ionic hairstyling polymer, an amphoteric hairstyling polymer or mixtures thereof. The cationic hairstyling polymer can be selected from the group consisting of: quaternized acrylates or methacrylates; quaternary homopolymers or copolymers of vinylimidazole; homopolymers or copolymers comprising a quaternary dimethdiallyl ammonium chloride; non-cellulosic cationic polysaccharides; cationic cellulose derivatives; chitosans and derivatives thereof; and mixtures thereof.

The hairstyling polymer can be an anionic hairstyling polymer or a mixture of anionic hairstyling polymers. The anionic hairstyling polymer can be selected from those comprising groups derived from carboxylic or sulfonic acids. Copolymers containing acid units are generally used in their partially or totally neutralized form, more preferably totally neutralized. The anionic hairstyling polymer can comprises: (a) at least one monomer derived from a carboxylic acid such as acrylic acid, or methacrylic acid or crotonic acid or their salts, or C4-C8 monounsaturated polycarboxylic acids or anhydrides (e.g., maleic, furamic, itaconic acids and their anhydrides) and (b) one or more monomers selected from the group consisting of: esters of acrylic acid and/or methacrylic acid (e.g., C1-C4 alkyl acrylate, methyl acrylate, ethyl acrylate, tert-butyl acrylate and the methacrylate derivatives of these); acrylate esters grafted onto a polyalkylene glycol such as polyethylene glycol (e.g., poly(ethyleneglycol)acrylate); hydroxyesters acrylate (e.g., hydroxyethyl methacrylate); acrylamides, methacrylamides which may or may not be substituted on the nitrogen by lower alkyl groups (C1-C4); N-alkylated acrylamide (e.g., N-tertbutylacrylamide); hydroxyalkylated acrylamide; amino alkylated acrylamide (e.g., dimethyl amino propyl methacrylamide); alkylacrylamine (e.g., tert-butylamino-ethyl methacrylate, dimethyl aminoethyl methacrylate); alkylether acrylate (e.g., 2 -ethoxyethyl acrylate); monoethylenic monomer such as ethylene, styrene; vinyl esters (e.g., vinyl acetate or vinyl propionate, vinyl tert-butyl-benzoate; vinyl esters grafted onto a polyalkylene glycol such as polyethylene glycol; vinyl ether; vinyl halides; phenylvinyl derivatives; allyl esters or methallyl esters; vinyllactams such as vinylpyrrolidone or vinylcapro lactam; alkyl maleimide, hydroxyalkyl maleimide (e.g., Ethyl/Ethanol Maleimide). When present the anhydride functions of these polymers can optionally be monoesterified or monoamidated. The anionic hairstyling polymer can comprise monomers derived from a sulfonic acid. Anionic polymers can comprise: (a) at least one monomer derived from a sulfonic acid such as vinylsulfonic, styrenesulfonic, naphthalenesulfonic, acrylalkyl sulfonic, acrylamidoalkylsulfonic acid or their salts and (b) one or more monomers selected from the group consisting of: esters of acrylic acid and/or methacrylic acid (e.g., C1-C4 alkyl acrylate, methyl acrylate, ethyl acrylate, tert-butyl acrylate and the methacrylate derivatives of these); acrylate esters grafted onto a polyalkylene glycol such as polyethylene glycol (e.g., poly(ethyleneglycol)acrylate); hydroxyesters acrylate (e.g., hydroxyethyl methacrylate); acrylamides, methacrylamides which may or may not be substituted on the nitrogen by lower alkyl groups (C1-C4); N-alkylated acrylamide (e.g., N-tertbutylacrylamide); hydroxyalkylated acrylamide; amino alkylated acrylamide (e.g., dimethyl amino propyl methacrylamide); alkylacrylamine (e.g., tert-butylamino-ethyl methacrylate, dimethyl aminoethyl methacrylate); alkylether acrylate (e.g., 2 -ethoxyethyl acrylate); monoethylenic monomer such as ethylene, styrene; vinyl esters (e.g., vinyl acetate or vinyl propionate, vinyl tert-butyl-benzoate; vinyl esters grafted onto a polyalkylene glycol such as polyethylene glycol; vinyl ether; vinyl halides; phenylvinyl derivatives; allyl esters or methallyl esters; vinyllactams such as vinylpyrrolidone or vinylcapro lactam; alkyl maleimide, hydroxyalkyl maleimide (e.g., Ethyl/Ethanol Maleimide). When present the anhydride functions of these polymers can optionally be monoesterified or monoamidated.

The anionic hairstyling polymers can be selected from: copolymers derived from acrylic acid such as the acrylic acid/ethylacrylate/N-tert-butylacrylamide terpolymer such as that sold as Ultrahold 8 by BASF®; Octylacrylamide/Acrylates/Butylaminoethyl/Methacrylate Copolymer such as that sold as Amphomer® by Akzo Nobel® methacrylic acid/ester acrylate/ester methacrylate such as that sold as Balance® CR by Akzo Nobel® Octylacrylamide/Acrylates/Butylaminoethyl Methacrylate Copolymer such as that sold as Balance® 47 by Akzo Nobel® methacrylic acid/hydroxyethylmethacrylate/various acrylate esters such as that known as Acudyne™ 1000 sold by Dow® Chemical; acrylates/hydroxyethylmethacrylate such as that sold as Acudyne˜ 180 by Dow® Chemical; methacrylic acid/ hydroxyethylmethacrylate/various acrylate esters such as that sold as AcudyneTM DHR by Dow® Chemical; n-butyl methacrylate/methacrylic acid/ethyl acrylate copolymer such as that sold as Tilamar® Fix A-1000 by DSM®; copolymers derived from crotonic acid, such as vinyl acetate/vinyl tertbutylbenzoate/crotonic acid terpolymers and the crotonic acid/vinyl acetate/vinyl neododecanoate terpolymers such as that sold as ResynTM 28-2930 by Akzo Nobel®. Hairstyling polymers derived from sulfonic acid can include: sodium polystyrene sulfonate sold as Flexan® 130 by Ashland™; sulfopolyester (also known as Polyester-5) such as that sold as Eastman AQ 48 by Eastman; sulfopolyester (also known as Polyester-5) such as that sold as Eastman AQ S38 by Eastman; sulfopolyester (also known as Polyester-5) such as that sold as Eastman AQ 55 by Eastman. The anionic hairstyling polymers can be selected from: copolymers derived from acrylic acid such as the acrylic acid/ethylacrylate/N-tert-butylacrylamide terpolymers (such as that sold as Ultrahold® 8 by BASF®); Octylacrylamide/Acrylates/B utylaminoethyl/Methacrylate Copolymer such as that sold as Amphomer; methacrylic acid/ester acrylate/ester methacrylate such as that sold as Balance® CR by Akzo Nobel® Octylacrylamide/Acrylates/Butylaminoethyl Methacrylate Copolymer such as that sold as Balance® 47 by Akzo Nobel® methacrylic acid/hydroxyethylmethacrylate/various acrylate esters such as that known as Acudyne® 1000 sold by Dow® Chemical; acrylates/hydroxyethylmethacrylate such as that sold as Acudyne® 180 by Dow® Chemical; methacrylic acid/ hydroxyethylmethacrylate/various acrylate esters such as that sold as Acudyne® DHR by Dow® Chemical; n-butyl methacrylate/methacrylic acid/ethyl acrylate copolymer such as that sold as Tilamar® Fix A-1000 by DSM®; copolymers derived from crotonic acid, such as vinyl acetate/vinyl tertbutylbenzoate/crotonic acid terpolymers and the crotonic acid/vinyl acetate/vinyl neododecanoate terpolymers such as that sold as Resyn™ 282930 by Akzo Nobel®. Hairstyling polymers derived from styrene sulfonic acid can include: sodium polystyrene sulfonate sold as Flexan® 130 by Ashland™; sulfopolyester (also known as Polyester-5) such as that sold as Eastman AQ 48 by Eastman; sulfopolyester (also known as Polyester-5) such as that sold as Eastman AQ S38 by Eastman; sulfopolyester (also known as Polyester-5) such as that sold as Eastman AQ 55 by Eastman.

The hairstyling polymer can be an anionic hairstyling polymer, and wherein the anionic hairstyling polymer is selected from: copolymers derived from acrylic acid such as the acrylic acid/ethylacrylate/N-tert-butylacrylamide terpolymers; Octylacrylamide/Acrylates/Butylaminoethyl/Methacrylate Copolymers; methacrylic acid/ester acrylate/ester methacrylates; Octylacrylamide/Acrylates/Butylaminoethyl Methacrylate Copolymer; methacrylic acid/hydroxyethylmethacrylate/various acrylate esters; acrylates/hydroxyethylmethacrylate; methacrylic acid/hydroxyethylmethacrylate/various acrylate esters; n-butyl methacrylate/methacrylic acid/ethyl acrylate copolymers; copolymers derived from crotonic acid, such as vinyl acetate/vinyl tertbutylbenzoate/crotonic acid terpolymers; and the crotonic acid/vinyl acetate/vinyl neododecanoate terpolymers; and mixtures thereof.

The hairstyling polymer can be a polyurethane dispersed or dissolved in solvent (e.g., water, ethanol, or another alcohol). Such polyurethanes can include those such as adipic acid, 1-6 hexandiol, neopentyl glycol, isophorone diisocyanate, isophorone diamine, N-(2-aminoethyl)-3-aminoethanesulphonic acid, sodium salt (also known as Polyurethane-48) such as that sold as Baycusan® C1008 by Bayer® and such as isophorone diisocyanate, dimethylol propionic acid, 4,4-isopropylidenediphenol/propylene oxide/ethylene oxide (also known as Polyurethene -14) such as that sold as a mixture under the name of DynamX® H₂O by Akzo Nobel®.

The hairstyling polymer can be a nonionic hairstyling polymer or a mixture of nonionic hairstyling polymers such as Luviskol® VA 64 from BASF® and PVP K30 from Ashland). The non-ionic hairstyling polymer can be a water-soluble natural polymer such as hydroxyalkylcelluloses (e.g., hydroxymethyl-, hydroxyethyl- or hydroxypropylcelluloses) and starches.

The hairstyling polymer can be an amphoteric hairstyling polymer or a mixture of amphoteric hairstyling polymers such as Diaformer® Z 731 N from Clariant®. Some other non-limiting examples of hairstyling polymers can be found in co-pending US 2023/0043188, filed by Brown, et al., on Jul. 27, 2022.

The hairspray composition can be substantially free of water-insoluble and/or water immiscible polymers and/or alcohol-insoluble polymers. Polymers of high molecular weight (e.g., >200,000 g/mol) may be avoided or only used at very low levels so that the hairspray composition does not exceed the desired viscosity. The hairspray composition may be substantially free of a polymer comprising at least two long hydrophobic grafts (e.g., linear fatty chains of 10 carbons or more). Such polymers with such grafts can lead to associative interactions in the hairspray composition which can drive viscosity up without contributing to the strength of the film delivered to the hair.

Ethanol-Based Hairspray

An ethanol-based hairspray composition may include an alcohol solvent present at 50% to 99.9% alcohol (e.g., 60% to 97%, 70% to 95%, or 80% to 95% ethanol, isopropanol or propanol), by weight of the hairspray compositions. Some non-limiting examples of alcohol solvents include ethanol, n-propanol, isopropanol, and combinations thereof. The hairspray polymer used in the composition should generally be soluble in the alcohol solvent, but need not necessarily be so.

The hairspray composition may further comprise other additional solvents, including water, provided that such additional solvents are chemically and physically compatible with the ingredients of the composition and that it does not substantially and unduly impair product performance. Some non-limiting formulation examples and additional ingredients that can be used in an ethanol-based hairspray can be found in WP1998/05379.

Ethanol-Free Hairspray

Some consumers may prefer an alcohol/ethanol-free or very low alcohol/ethanol hairspray because they can have a purer fragrance (in view of the absence of an alcohol smell), less observed hair dryness and reduced brittleness effects to the hair, and consumers may perceive them to be more environmentally friendly and/or healthier to use. Ethanol-free hairspray compositions herein contain less than 2% alcohol/ethanol, (e.g., less than 1%, 0.5%, or even less than 0.25% alcohol/ethanol), by weight of the hairspray composition. In some embodiments, the hairspray composition contains 0% ethanol or alcohol. The hairspray polymer used in the composition should generally be water soluble, but need not necessarily be so.

The hairspray composition can include 30% to 99% water (e.g., 60% to 98% water, 70% to 97% water, 80% to 96%, or 85% to 96%), by weight of the hairspray composition. The water can provide a solvent for the hairstyling polymer and other ingredients in the hairspray composition. It may be desirable to use ingredients for the hairspray composition that are water soluble.

If the spray rate is greater than 0.45 g/sec for an ethanol-free hairspray product, then the on-hair drying time may be too long for consumer satisfaction. This is unique to the ethanol-free hairsprays described herein as compared to traditional ethanol-based hairsprays, which typically contain a volatile alcohol and have a delivery rate of 0.55 g/sec to 0.85 g/sec. The delivery rate can typically be adjusted by altering the pressure inside the container (increased pressure correlates with faster delivery rate) and/or the orifices in the spraying device, such as the orifices in the nozzle, orifices in the valve, and the inner diameter of the dip tube

Optional Ingredients

The hairspray composition can include a panthenol compound and/or a silicone compound. The panthenol compound may be selected from the group consisting of: panthenol, a pantothenic acid derivative, and mixtures thereof. The panthenol compound can be selected from the group consisting of: D-panthenol ([R]-2,4-dihydroxy-N-[3-15-(hydroxypropyl)]-3,3-dimethylbutamide), D/L-panthenol, pantothenic acids and their salts, panthenyl triacetate, royal jelly, panthetine, pantotheine, panthenyl ethyl ether, pangamic acid, pantoyl lactose, Vitamin B complex, and mixtures thereof. The panthenol compound can be useful in view of providing excellent hair look and feel benefits. The hairspray composition may comprise 0.1% to 0.6% (.e.g., 0.1% to 0.3%) of a panthenol compound, by weight of the hairspray composition. The hairspray composition can include a silicone compound.

The silicone can be useful because it gives a smoother feel and also shine to the hair. The silicone compound can be a dimethicone compound. In The silicone compound can be a PEG dimethicone, for example PEG-12 dimethicone.

The hairspray composition may further include a surfactant present at 1% or less (e.g., 0.6% or less, 0.4% or less, or 0.3% or less), by weight of the hairspray composition. The surfactant may be selected from the group consisting of cationic surfactants, non-ionic surfactants, anionic surfactants, and mixtures thereof.

The hairspray composition can include a neutralizer. Suitable neutralizers may include potassium hydroxide, sodium hydroxide, triisopropanolamine (TIPA), 2-aminobutanol, 2-aminomethyl propanol (AMP), aminoethylpropandiol, dimethyl stearamine (Armeen 18 D), sodium silicate, tetrahydroxypropyl ethylenediamine (Neutrol® TE), ammonia (NH3), triethanolamine, trimethylamine (Tris AminoUltra), aminomethylpropandiol (AMPD). The neutralising agent can be 2-aminobutanol, ammonia, or 2-aminomethyl propanol.

The hairspray composition may include at least one preservative. The preservative may be present in an amount of less than 1.5%, or 0% to 1%, or 0.01% to 1%, by weight of the hairspray composition.

The hairspray composition may further include a perfume or fragrance. It may be desirable to limit the amount of perfume or fragrance to 0.5% (e.g., 0% to 0.4% or 0.03% to 0.3%), by weight of the hairspray composition.

The hairspray composition can include vitamins, amino acids and preservatives.

Additional examples of hairspray compositions and aerosol spray containers that may be suitable for use herein are described in U.S. Pat. Nos. 9,986,809, 10,131,488, and 10,426,979.

Dry Shampoo

In some aspects, the hair care composition is a dry shampoo. Dry shampoo products are spray hair products that reduce the appearance of oil and dirt on a user's hair and/or scalp. Unlike traditional shampoos and conditioners, dry shampoo can be applied to dry hair and does not need to be washed out. In some aspect, the dry shampoo composition includes a carrier and an oil absorbing starch. The dry shampoo composition can also contain optional ingredients including rheology modifiers, polar activators, fragrances, and other minor ingredients. Some non-limiting examples of performance attributes that are important for dry shampoos are quick evaporation that leads to a fast dry time/no wet hair feel, ability to dissolve scalp oil for clean look dry shampoo benefit, low or no odor, low viscosity, low surface tension and compatibility with the target surface (e.g., hair or an applicator). The dry shampoo composition may have a pH of 3 to 9 (e.g., 4 to 6).

In some aspects, the dry shampoo may use ethanol as a carrier. However, it has been found that using hexamethyldisiloxane (HMDS), the lowest molecular weight linear volatile silicone, with a viscosity of 1 cSt or less (e.g., 0.65 cSt or less) as the carrier in a dry shampoo composition can create a product with consumer acceptable performance that also has 55% or less VOC. The HDMS carrier can also deliver conditioning and/or smoothing and/or frizz reducing benefits to hair. Further, HMDS feels like it is at room temperature when dispensed, whereas traditional ethanol-based dry shampoos feel cold when they are dispensed. Interestingly, HMDS, a silicone material, is generally believed to make hair feel heavy and greasy, and thus using a silicone oil carrier for a dry shampoo is not intuitive, especially when the intended benefit of a dry shampoo is to absorb hair oil and reduce the appearance of oily roots. The dry shampoo product can include 20% or more HMDS (e.g., >25%, >30%, >35%, or even >40%), but typically less than 60% (e.g., 20% to 60%, 25% to 55%, 30% to 50%, 35% to 45% or 38% to 43%). The term “dry shampoo product,” when referring to ingredient levels in the dry shampoo product, means the weight percentage of the subject ingredient based on the total weight of the dry shampoo composition and propellant.

In some aspects, the dry shampoo composition may be free or substantially free of ethanol, water, surfactant, parabens, propellant 152a (1,1 Difluoroethane), and/or polymers including, but not limited to, film-forming polymers.

In some aspects, the dry shampoo composition is dispensed at a rate of 0.4 g/s to 0.9 g/s, 0.45 g/s to 0.75 g/s, 0.5 g/s to 0.7 g/s, 0.55 g/s to 0.7 g/s, and 0.57 g/s to 0.65 g./s), as determined by the Delivery Rate method. The dispensed composition can have a Dv50 of 5μm to 250 μm (e.g., 10 to 225 μm) and deliver 0.025 g/s to about 0.2 g/s of oil absorbing starch (e.g., 0.05 g/s to 0.15 g/s, 0.06 g/s to 0.1 g/s, 0.07 g/s to 0.08 g/s, or about 0.075 g/s) to the target surface (e.g., hair and scalp). The particles size and dispensing rates are tailored to ensure that the composition has a desirable drying time on hair and delivers enough oil absorbing starch in each particle (droplet) to provide sufficient oil absorption. The amount of oil absorbing starch dispensed from the container can be determined according to the Delivery Rate method.

Other properties that are important for dry shampoo products include oil absorption, particle size (Dv50), container pressure, viscosity and low residue. These properties are be determined using known methods such as those disclosed in co-pending U.S. Ser. No. 17/892,194 filed by

Oil Absorbing Starch

The dry shampoo product may include 1% to 15% oil absorbing starch (e.g., 3% to 12% or even 6% to 10%), by weight, based on the weight of the dry shampoo product. The oil absorbing starch may be dispersed in the carrier. Some non-limiting examples of oil absorbing starch that may be suitable for use herein include rice starch, corn starch (also known as maize starch), potato starch, silica, clays, tapioca starch and combinations thereof. Tapioca starch may be particularly suitable for use herein. Particulate tapioca starch may be obtained from the cassava (Manihot esculental) root by conventional methods known in the art.

In some aspects, the oil absorbing starch can be a particulate tapioca starch such as a hydrophobically modified particulate tapioca starch, which may be present in the composition at a ratio of hydrophobically modified particulate tapioca starch to unmodified particulate tapioca starch of 2:1 or greater. In some aspects, the particulate tapioca starch may be an organically modified particulate tapioca starch or a silicone grafted particulate tapioca starch. Silicone grafted particulate tapioca starch may be purchased under the trade name Dry Flo® TS and under the INCI name Tapioca Starch Polymethylsilsesquioxane. One example of a commercially available silicone modified particulate tapioca starch is CAS no. 68989-12-8.

Rheology Modifier

In some examples, the dry shampoo composition can include one or more rheology modifiers (e.g., thickeners). Some non-limiting examples of rheology modifiers include water-swellable clays (e.g., laponite, bentolite, montmorilonite, smectite and hectorite), alginic acid-based materials (e.g sodium alginate and alginic acid propylene glycol esters), homopolymers based on acrylic acid, methacrylic acid and/or derivatives thereof (e.g, polyacrylate, polymethacrylate, polyethylacrylate, and polyacrylamide), crosslinked acrylic polymers (e.g., carbomers), hydrophobically modified cellulose derivatives, hydrophobically modified alkoxylated urethane polymers, PEG-150/decyl alcohol/SMDI copolymer, PEG-150/stearyl alcohol/SMDI copolymer, polyurethane-39, hydrophobically modified alkali swellable emulsions (e.g., hydrophobically modified polyacrylates, hydrophobically modified polyacrylic acids, and hydrophobically modified polyacrylamides), hydrophobically modified polyethers (e.g., PEG-120-methylglucose dioleate, PEG-(40 or 60) sorbitan tetraoleate, PEG-150 pentaerythrityl tetrastearate, PEG-55 propylene glycol oleate, PEG-150 distearate), cellulose and cellulose derivatives (e.g, microcrystalline cellulose, carboxymethylcelluloses, hydroxyethylcellulose, hydroxypropylcellulose, hydroxypropylmethylcellulose, methylcellulose, ethylcellulose, nitro cellulose, cellulose sulfate and cellulose powder), guar and guar derivatives (e.g., hydroxypropyl guar, and hydroxypropyl guar hydroxypropyl trimonium chloride), dibenzylidene sorbitol, carrageenan, pectin, agar, quince seed (Cydonia oblonga Mill), starch-derivatives (e.g., carboxymethyl starch and methylhydroxypropyl starch), algae extracts, dextran, succinoglucan, and pulleran, polyethylene oxide, polypropylene oxide, polyvinylpyrrolidone, polyvinylalcohol, polyethyleneimine, silicas (e.g., fumed silica, precipitated silica and silicone-surface treated silica) and combinations of these.

The rheology modifier may be present at 0.5% to 3% (e.g., 0.75% to 2%, 1% to 1.75% or even 1.25% to 1.5%) based on the weight of the dry shampoo product.

Polar Activators

In some examples, the dry shampoo composition can include a polar activator such as methanol, ethanol, acetone, propylene carbonate, water, triethyl citrate, propylene carbonate and combinations thereof. The dry shampoo product can have better homogeneity of the oil absorbing starch suspended in the carrier compared to a dry shampoo product that does not include the rheology modifier when a rheology modifier and/or a polar activator is included in the formulation. The polar activator may be present at 0.1% to 1% (e.g., 0.2% to 0.8%, 0.3% to 0.7%, or even 0.4% to 0.6%) by weight of the dry shampoo product.

Optional Ingredients

The dry shampoo compositions described herein may also comprise any other suitable optional ingredients as desired. Some non-limiting examples of optional ingredients include natural oils (e.g., olive oil, argan oil, jojoba oil, passion fruit oil, peppermint oil and spearmint oil), scalp health actives (e.g., zinc pyrithione, climbazole, octopirox, vitamin E, vitamin F, salicylic acid, glycols, glycolic acid, PCA, PEGs, erythritol, glycerin, lactates, hyaluronates, allantoin and other ureas, betaines, sorbitol, glutamates, xylitols, menthol, menthyl lactate, isocyclomone, benzyl alcohol, aloe and combinations thereof. Still other examples of optional ingredient classes include, without limitation, aesthetic components such as fragrances, pigments, colorings/colorants, essential oils, sensates, anti-foaming agents, preservatives, biological additives, buffering agents, bulking agents, chelating agents, chemical additives, astringents, biocides, film formers or materials, pH adjusters, reducing agents, sequestrants, and surfactants.

Propellant

The hair care products herein may include 30% to about 70% (e.g., 40% to 65% and 49% to 55%), by weight of the product, of a propellant. In some aspects, the propellant is a non-hydrocarbon compressed gas propellant such as nitrogen, air, carbon dioxide, nitrous oxide, other inert gases and combinations thereof. The volume of the propellant stored within the container may be from about 10 mL, 20 mL, 30 mL, or 40 mL to about, 80 mL, 70 mL, 60 mL, or 50 mL. Propellant pressure may affect the mass flow and/or spray characteristics of the hair care product. It is believed that when the propellant concentration is too low, the total fill of the container may result in too high of a mass flow of the composition and/or poor spray characteristics (i.e. a narrow spray pattern).

Adsorbent

The aerosol products herein include an adsorbent material. The adsorbent material is generally in the form of a porous solid particle that has an affinity to bind liquid or gas molecules to its surface. Some non-limiting examples adsorbent materials include activated carbon, zeolite, clay, chitosan, alumina, silica, zirconia and titania. A particularly suitable adsorbent material for use herein is activated carbon. The adsorbent material should be selected to adsorb the compressed gas propellant used in the product.

Container and Spray Device

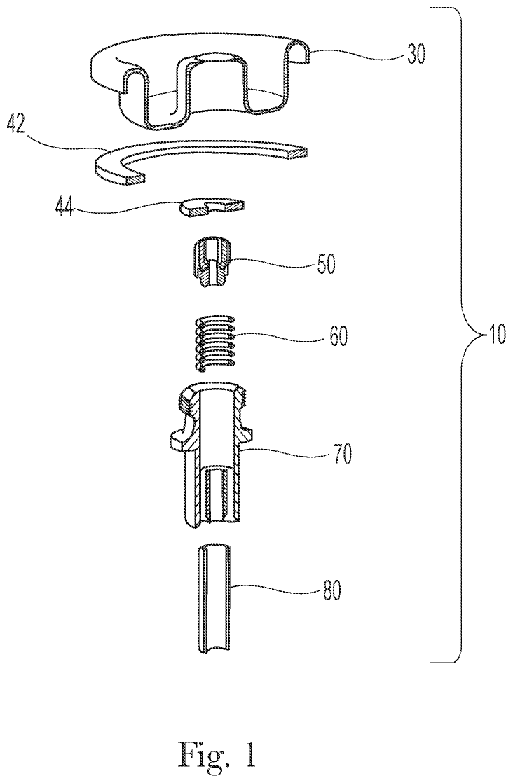

FIG. 1 illustrates an example of a bag-on-valve assembly (10) that includes a mounting cup (30), an outer gasket (42), an inner gasket (44), a valve seat (50), a spring (60), a housing (70) and a dip tube (80), which includes a fitment (e.g., a rib) to which a bag (not shown) can be attached. The valve assembly (10) may include a male valve (as illustrated) or a female valve to which an actuator (200) may be connected.

In some examples, the aerosol container can have a dispensing system with one ingredient containing reservoir, like a pouch or bag, filled with a product and the spray device container can be filled or partially filled with compressed gas. In this example, a first tube can extend into the containing reservoir and can carry product to the valve assembly and the second tube can extend into the spray device container and can carry compressed gas to the valve assembly. The product and the compressed gas can mix in the valve assembly or actuator. Unlike traditional bag-on-valve executions, when the composition is dispensed, gas is also dispensed from the spray device, decreasing the pressure inside the spray device container.

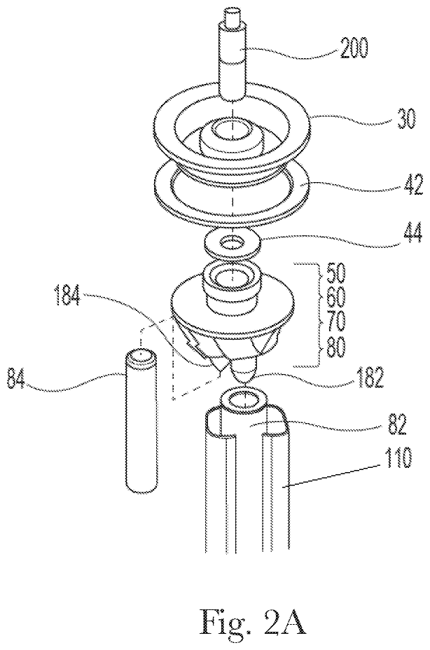

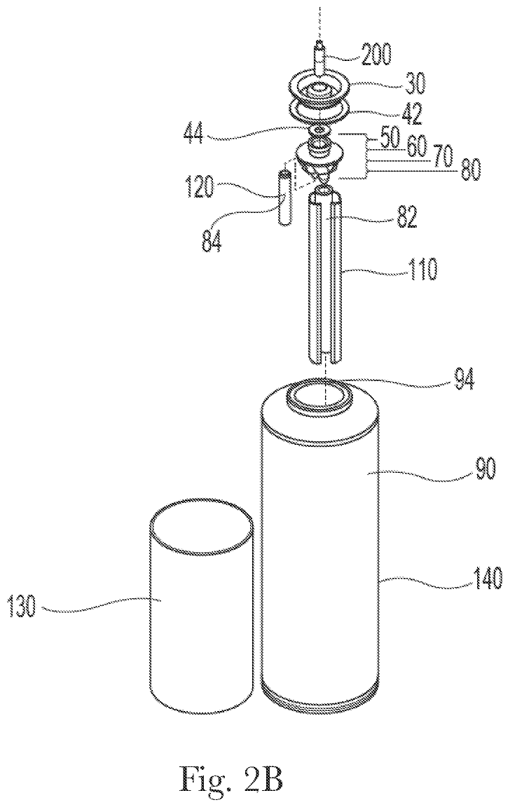

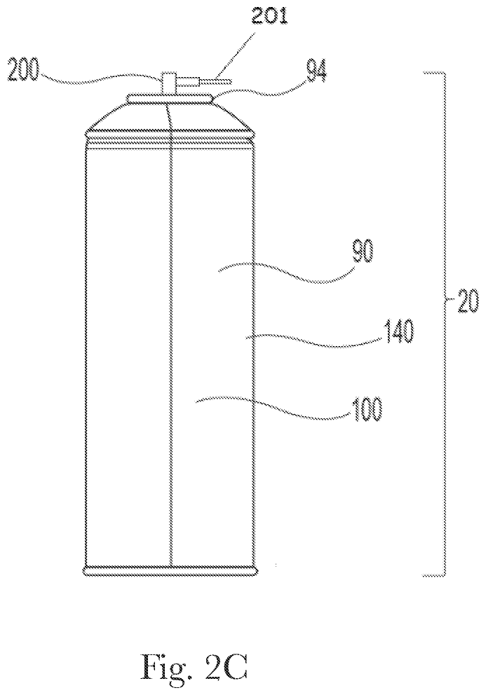

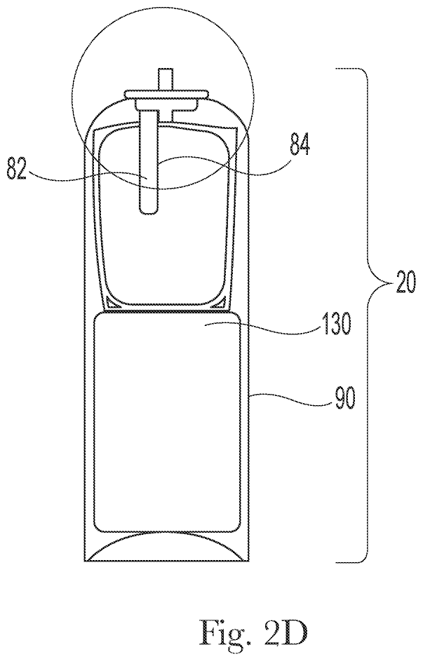

In other examples, like those shown in FIGS. 2B-D, the aerosol container can have a dispensing system in which two bags are filled, allowing two different products to be dispensed, either as separate products, or more typically as a single product, with mixing occurring in the valve assembly or actuator. In the latter case the valve assembly can have a dip tube (80) which splits/bifurcates into two, each with fitments for connecting a bag thereto. The bags are typically 3-layer or 4-layer pouches made respectively of polyacrylate/aluminum/ polypropylene or polyethylene (PA/ALU/PP or PE) or polyethylene terephthalate/aluminum/orientated polyimide/ polypropylene or polyethylene (PET/ALU/OPAi PP or PE).

In some examples, as illustrated in FIGS. 2A and 2B, the valve assembly (10) can have a mounting cup (30), a pair of gaskets (42 and 44), a valve seat (50), spring (60) and housing (70), with a dip tube (80) which divides, at its lower end, to receive two tubes (82; 84) on respective fitments (182; 184). An ingredient containing reservoir (110), which can be a rigid sided container, bag or pouch can be connected to the first tube (82). First tube (82) and second tube (84) can extend into spray device container (90), which is filled or partially filled with a dispensing carrier gas (140), typically a compressed gas, like carbon dioxide or nitrogen. Optionally, the second tube (84) can act to prevent fine particles of activated carbon (130) from being dispensed. Activated carbon (130) can adsorb the dispensing carrier gas which fills or partially fills the spray device (90). On actuation, the dispensing carrier gas (140) is released together with the hair care composition (100) stored in containing reservoir (110), and the hair care composition (100) and carrier gas (140) mix as they pass through the valve assembly (10) and actuator (200) to exit the spray device container, for example, via spray nozzle (201).

The spray device (20) illustrated in FIG. 2D, comprises a spray device container or cannister (90) (FIG. 2B) which is filled or partially filled with activated carbon (130) and the valve assembly (10) is crimped, or otherwise sealed, to close the opening (94) (FIG. 2B) of the dispensing cannister (90). The spray device (20) may be charged with a dispensing carrier gas (140) before or after crimping or otherwise sealing. Similarly, if the containing reservoir (110) is a bag or pouch it may be filled with its ingredients (100) before or after crimping.

An example of the filled spray device (20) is illustrated in FIGS. 2C and 2D.

The hair care product (100) can be in the form of a liquid or oil but could be any mobile phase. The hair care product (100) can be a stable single phase or it can be more than one phase.

If the containing reservoir (110) is made of a flexible material, such as a bag or pouch, it can be rolled into a hollow cylinder (see FIG. 2B) around first tube (82) for ease of insertion, and the adjoining second tube (84) can be inserted directly into the dispensing cannister or into a canister pre-filled with granular activated carbon (130), first and second tubes (82) and (84) being connected to the valve assembly via connectors (182) and (184) respectively. (If present, the granular carbon can easily be displaced to accommodate the rolled-up bag which is now surrounded by the activated carbon granules). The canister is then crimped, and the bag side of the canister is filled with the required quantity of hair care product (100). The canister is then filled with pressurized gas (e.g., air, oxygen, nitrogen or carbon dioxide). On actuating the valve, the assembly enables the carrier gas (140), which is mixed or physically saturated, at least in part, with hair care product, to be dispensed. Some non-limiting examples of dispensers with bifurcated dip tubes where the pressurized gas and the product mix in the valve assembly before exiting the dispenser via an actuator spray nozzle are disclosed in WO2020/021473.

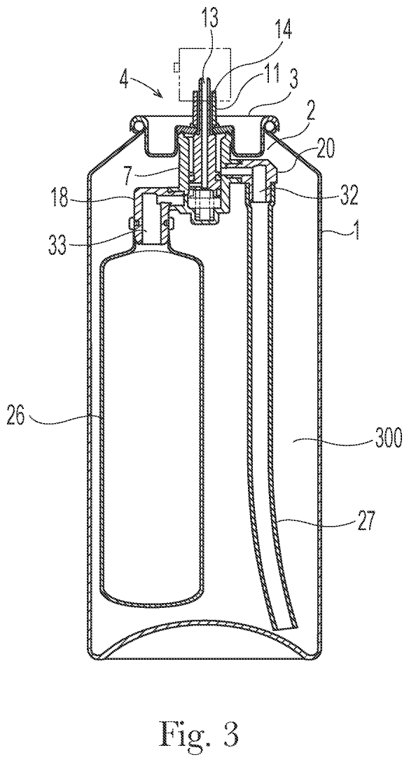

FIG. 3 is another example of an aerosol dispenser for antiperspirant or deodorant products. In this example, the pressurized gas (300) is directly filled in the aerosol container (1). Containing reservoir (26) can be filled with the hair care product. The containing reservoir (26) can be easily deformed with the pressurized gas. Further, the pressurized gas may be connected to the second passage (14) disposed at the stem (11), via a dip tube (27), while the containing reservoir (26) is connected to the first passage (13) disposed at the stem (11).

In one example, the second passage (14) and first passage (13) are formed separately up to the top end of the stem (11) having a lower end thereof arranged inside the housing (7), while a second seal member seals the second liquid and the second passage (14) when the stem (11) is not pressed. In another example, the second the second passage (14) and first passage (13) are formed separately up to the valve assembly or actuator and the antiperspirant or deodorant composition combines with the pressurized gas before exiting the dispenser. Some non-limiting examples of aerosol dispensing devices with a valve assembly that can mix the product with the pressurized gas in the valve assembly or the actuator immediately before dispensing are disclosed in U.S. Pat. No. 7,798,366.

### METHODS

Delivery Rate

The delivery rate of the aerosol hair care products herein is determined according to ASTM D 3069-94, “Standard Test Method for Delivery Rate of Aerosol Products.” In this method, the delivery rate of the product is determined by measuring the mass of product lost over a specified actuation time.

The method is conducted at room temperature (i.e., 21° C.) with an actuation time of 2 seconds to 10 seconds. The delivery rate (also referred to as spray rate) is determined by the equation:

Delivery Rate (g/s)=Mass loss (g)/Actuation time (s)

The delivery rate of oil absorbing starch in a dry shampoo product can be determined by the following equation:

Delivery Rate of Oil Absorbing Starch (g/s)=Delivery rate (g/s)*% Oil absorbing starch in dry shampoo product.

### EXAMPLES

The following examples are given solely for the purpose of illustration and are not to be construed as limitations of the invention as many variations thereof are possible without departing from the spirit and the scope of the invention.

### Example 1

### Ethanol-Free Hairspray Formulas

TABLE 2

| | A | B | C | D | E | F | G | H | I | J |
|---|---|---|---|---|---|---|---|---|---|---|
| | Wt % | | | | | | | | | |
| Acrylates copolymer ¹ | 4.20 | 7.31 | 4.50 | 2.90 | 4.50 | 1.60 | | | | |
| Polyurethane-14/AMP- | 1.10 | 1.83 | 1.30 | 2.90 | | 2.00 | | | | |
| acrylates polymer blend ² | | | | | | | | | | |
| Octylacrylamide/acrylates/ | 0.60 | 1.1 | | | | | 1.7 | | | |
| butylaminoethyl/methacrylate | | | | | | | | | | |
| copolymer ⁴ | | | | | | | | | | |
| Vinylpyrrolidone/ | | | | | | | | 7.00 | | 5.75 |
| vinylacetate copolymer ⁵ | | | | | | | | | | |
| Methacrylic acid/ | | | 0.60 | 1.50 | | 3.00 | | | | |
| hydroxyethylmethacrylate ³ | | | | | | | | | | |
| Polyquaternium-16 ⁶ | | | | | | | | | 2.5 | |
| Chitosan ⁷ | | | | | | | | | 0.75 | |
| Hydroxyethylcellulose | | | | | | | | | | 0.83 |
| dimethyldiallyammonium | | | | | | | | | | |
| chloride[PQ4] ⁸ | | | | | | | | | | |
| 2-aminomethyl propanol | 0.70 | 1.20 | 0.36 | 0.34 | 0.48 | | 0.32 | | | |
| (AMP) | | | | | | | | | | |
| Potassium hydroxide | | | 0.48 | 0.45 | | 0.98 | | | 0.40 | |
| Fragrance | 0.08 | 0.16 | 0.10 | 0.10 | 0.10 | 0.10 | 0.35 | 0.18 | 0.15 | 0.2 |
| Dehyquart A-CA /detex | 0.1 | 0.2 | 0.2 | 0.2 | | | | | 0.2 | 0.2 |
| (cationic surfactant) | | | | | | | | | | |
| Dehydol LS 4 Deo N (non- | 0.05 | 0.1 | 0.05 | 0.05 | | | | 0.10 | | 0.10 |
| ionic surfactant) | | | | | | | | | | |
| PEG-12 dimethicone | 0.13 | 0.26 | | 0.13 | | | | | | |
| Disodium EDTA | 0.11 | 0.22 | 0.11 | 0.11 | 0.11 | 0.11 | 0.11 | 0.11 | 0.11 | 0.11 |
| Phenoxyethanol | 0.50 | 1.00 | 0.50 | 0.50 | 0.50 | 0.50 | 0.50 | 0.50 | 0.50 | 0.50 |
| Methylparaben | 0.10 | 0.20 | 0.10 | 0.10 | 0.10 | 0.10 | 0.10 | 0.10 | 0.10 | 0.10 |
| Water | QS | QS | QS | QS | QS | QS | QS | QS | QS | QS |

¹ = Balance ® CR Polymer
² = DynamX ™ H20
³ = Acudyne ™ 1000
⁴ = Amphome ™
⁵ = Luviskol ™ VA64
⁶ = Luviquat ™ FC550
⁷ = Hydagen ™ HCMF
⁸ = Celquat ™ L-200

### Example 2

### Ethanol-Based Hairspray Formulas

TABLE 3

| | A | B | C | D | E |
|---|---|---|---|---|---|
| | Wt % | | | | |
| VA/Crotoantes/Vinyl | 2.16 | 3.61 | | | 5.36 |
| Neodecanoate Copolymer ¹ | | | | | |
| Octylacrylamide Acrylates | 1.94 | 3.23 | | | 4.78 |
| Copolymer² | | | | | |
| Octylacrylamide/Acrylates/ | | | 3.25 | 4.50 | |
| Butylaminoethyl/Methacrylate | | | | | |
| Copolymer ³ | | | | | |
| Vinylpyrrolidone/Vinylacetate | | | | | |
| Copolymer ⁴ | | | | | |
| Water | 4.37 | 7.20 | 0.15 | 0.15 | 10.19 |
| 2-aminomethyl propanol (AMP) | 0.55 | 0.92 | 0.72 | 0.98 | 1.43 |
| Tapioca Starch | | | 1.50 | | |
| Silica | | | 0.25 | | |
| Polysorbate-80 | 0.13 | 0.22 | | | 0.13 |
| Ammonium Benzoate | 0.20 | 0.33 | | | 0.2 |
| Monoethanolamine Borate | 0.20 | 0.33 | | | |
| Fragrance | 0.27 | 0.45 | 0.10 | 0.10 | 0.39 |
| Triethyl Citrate | | | 0.15 | | |
| Ethanol | QS | QS | QS | QS | |

¹ Resyn ™ 28-2930
²Amphomer ™
³ Balance ™ 47
⁴ Luviskol ™ VA64

### Example 3

### Dry Shampoo Formulas

TABLE 4

| | A | B | C | D |
|---|---|---|---|---|
| | Wt % | | | |
| Ethanol | 11.31 | 11.28 | | |
| Hexamethyldisiloxane | | | 41.87 | 42.37 |
| Modified Tapioca Starch | 8.51 | 8.51 | 8.51 | 6.5 |
| Tapioca Starch | | | | 1.2 |
| Silica | | | | 0.25 |
| Minors | 0.06 | 0.06 | 0.06 | 0.06 |
| Fragrance | 0.12 | 0.12 | 0.12 | 0.12 |
| Dimethyl ether | 80 | 38.4 | 49.50 | 49.50 |
| HFC-152a | | 41.6 | | |
| Total % VOC | 91.31 | 49.68 | 49.50 | 49.50 |
| Dry Time | Control | Approx | Approx | Approx |
| | | equal to | equal to | equal to |
| | | Ex. A | Ex. A | Ex. A |
| Oil absorption at hair roots | Control | Approx | Approx | Approx |
| | | equal to | equal to | equal to |
| | | Ex. A | Ex. A | Ex. A |
| Visible white powder residue | Control | Approx | <Ex. A | <Ex. A |
| | | equal to | | |
| | | Ex. A | | |
| Pressure (psig) | 50 | 61 | 57 | 57 |
| Average particle size, | 13.72 | 13.60 | 17.61 | 18.86 |
| (Dv50) (μm) | | | | |
| Spray Rate (g/s) | 0.60 | 0.68 | 0.59 | 0.62 |

In Table 4, Example A is a conventional dry shampoo product comprising a hydrocarbon propellant, an ethanol carrier and a modified tapioca starch oil absorber. Example A has a consumer preferred dry time, oil absorption at hair roots, visible residue after application, and spray properties that include pressure, average particle size (Dv50), and spray rate. Example B is a dry shampoo product similar to Example A, except that a portion of the hydrocarbon propellant is replaced with HFC-152a (1,1-Difluoroethane), which is an organoflurine (i.e., not a VOC). Example generally provides consumer preferred properties, but HFC-152a may not be consumer or industry preferred.

Examples C and D in Table 4 use an HDMS carrier instead of ethanol. Therefore, the total % VOC in the compositions is 49.5%. In addition, Examples C and D are ethanol and water free.

The test results summarized in Table 4 show that Examples C and D, which are ethanol and water free, contain HMDS and have a total VOC % less than or equal to 50%, have similar spray properties and performance to Example 1, which includes ethanol and has a total VOC content greater than 90%.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”. All numeric values (e.g., dimensions, flow rates, pressures, concentrations, etc.) recited herein may be modified by the term “about”, even if not expressly so stated with the numeric value.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An aerosol hair care product comprising:
a) a container;
b) an actuatable valve assembly joined to the container, the actuatable valve assembly comprising a mounting cup, one or more gaskets, a valve seat, a spring, a dip tube and a housing;
c) a compressed gas propellant contained in the dispenser container, wherein the compressed gas propellant is selected from nitrogen, carbon dioxide and combinations thereof;
d) an adsorbent, wherein the adsorbent adsorbs as least some of the compressed gas propellant;
e) a reservoir disposed inside the container, wherein the reservoir contains a hair care composition, the reservoir being operatively connected to the actuatable valve assembly via a first dip tube and a second tube such that, on actuation of the valve assembly, the composition and the compressed gas propellant travel along the first tube and the second tube, respectively, and mix in the valve assembly before exiting the dispenser container via an actuator spray nozzle, or the compressed gas propellant travels along the second tube into the reservoir and carries the composition along the first tube where they mix in the valve assembly before exiting the dispenser container via the actuator spray nozzle; and
f) wherein the hair care composition comprises an anionic hairstyling polymer and an ethanol-free carrier.

2. The hair care product of claim 1, wherein the anionic hairstyling polymer is a copolymer derived from acrylic acid, crotonic acid and combinations thereof.

3. The hair care product of claim 2, wherein the copolymer derived from acrylic acid is selected from acrylic acid/ethylacrylate/N-tert-butylacrylamide terpolymers, acrylates/hydroxyesters acrylates copolymers of butyl acrylate, methyl methacrylate, methacrylic acid, ethyl acrylate and hydroxyethyl methacrylate, polyurethane-14/AMP-acrylates copolymer blend, octylacrylamide/acrylates/butylaminoethyl/methacrylate copolymers, methacrylic acid/ester acrylate/ester methacrylate copolymers, acrylates/hydroxyethylmethacrylate copolymers, methacrylic acid/ hydroxyethylmethacrylate/acrylate ester copolymers; N-butyl methacrylate/methacrylic acid/ethyl acrylate copolymers and combinations thereof.

4. The aerosol hairspray product of claim 2, wherein the copolymer derived from crotonic acid is selected from vinyl acetate/vinyl tertbutylbenzoate/crotonic acid terpolymers, crotonic acid/vinyl acetate/vinyl neododecanoate terpolymers and combinations thereof.

5. The aerosol hairspray product of claim 1, wherein the hairspray product has a spray rate of 0.3 g/sec to 1.0 g/sec according to the Spray Rate method, and wherein the spray rate varies by no more than 30% over the life of the hair care product.

6. The aerosol hairspray product of claim 1, wherein the hairspray product has a Dv50 of 20 μm to 90 μm, according to the Particle Size Distribution method.

7. The aerosol hairspray product of claim 6, wherein the Dv50 varies by no more than 20 μm from when the container contains 100% of the hairspray composition and when the container contains 25% of the hairspray composition.

8. The aerosol hairspray product of claim 1, wherein the hairspray product has a spray diameter of 5 cm to 15.25 cm.

9. The aerosol hairspray product of claim 8, wherein the spray diameter varies by no more than 30% from when the container contains 100% of the hairspray composition and when the container contains 25% of the hairspray composition.

10. The aerosol hairspray product according to claim 1, wherein the compressed gas propellant comprises at least one of nitrogen and carbon dioxide.

11. The aerosol hairspray product according to claim 1, wherein the adsorbent material comprises at least one of activated carbon and zeolite.

12. An aerosol hair care product comprising:
a) a container;
b) an actuatable valve assembly joined to the container, the actuatable valve assembly comprising a mounting cup, one or more gaskets, a valve seat, a spring, a dip tube and a housing;
c) a compressed gas propellant contained in the container, wherein the compressed gas propellant is selected from nitrogen, carbon dioxide and combinations thereof;
d) a reservoir disposed inside the container, wherein the reservoir contains a hair care composition, the reservoir being operatively connected to the actuatable valve assembly via a first dip tube and a second tube such that, on actuation of the valve assembly, the composition and the compressed gas travel along the first tube and the second tube, respectively, and mix in the valve assembly before exiting the dispenser container via an actuator spray nozzle, or
the compressed gas propellant travels along the second tube into the reservoir and carries the composition along the first tube where they mix in the valve assembly before exiting the dispenser container via the actuator spray nozzle; and
e) wherein the hair care composition is a dry shampoo comprising an oil absorbing starch dispersed in a volatile solvent, wherein the volatile solvent comprises a volatile silicone having a viscosity of 1 mPa-s or less, and wherein the dry shampoo comprises 55% or less of volatile organic compounds, by weight of the dry shampoo product.

13. The hair care product of claim 12, wherein the dry shampoo is substantially free of at least one of water, ethanol, polymers and surfactants.

14. The hair care product of claim 12, wherein the dry shampoo further comprises at least one of a rheology modifier, a polar activator and a polar activator modifier that improves the homogeneity of the oil absorbing starch suspended in the carrier, as compared to the dry shampoo composition that does not include the rheology modifier.

15. The hair care product of claim 14, wherein the rheology modifier comprises a water-swellable clay selected from laponite, bentolite, montmorilonite, smectite, hectorite and combinations thereof.

16. The hair care product of claim 14, wherein the polar activator is selected from methanol, ethanol, acetone, propylene carbonate, water, triethyl citrate, propylene carbonate and combinations thereof.

17. The hair care product of claim 12, wherein the volatile silicone is hexamethyldisiloxane.

18. The hair care product of claim 12, wherein the dry shampoo composition feels dry within about 10 seconds of being dispensed from the container.

19. The hair care product of claim 12, wherein about 0.025 g to about 0.2 g of oil absorbing starch is dispensed in one second when the valve assembly is actuated.

20. The hair care product of claim 12, wherein the dry shampoo composition, when dispensed, has an average particle size (Dv50) of 5 μm to about 250 μm according to the Particle Size Distribution method.
